(19) United States
(12) Patent Application Publication
(10) Pub. No.: US 2026/0280767 A1
(43) Pub. Date: Sep. 17, 2026

(54) DATA TRANSMISSION CONTROL METHOD, SYSTEM AND APPARATUS, AND COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 19/471,354

(22) PCT Filed: Apr. 6, 2023
(86) PCT No.: PCT/CN2023/086704

§ 371 Date: Sep. 30, 2025

(51) Int. Cl. H04L 1/08

(52) U.S. Cl. CPC H04L 1/08

(57) ABSTRACT

A method for controlling data transmission includes sending indication information to a terminal. The indication information is configured to instruct a packet data convergence protocol (PDCP) entity of the terminal to enable a duplication mechanism for a data packet of a target type, or the indication information is configured to instruct the PDCP entity of the terminal not to enable the duplication mechanism for the data packet of the target type.

### CROSS-REFERENCE TO RELATED APPLICATION

The present application is a U.S. National Stage of International Application No. PCT/CN2023/086704, filed on Apr. 6, 2023, the contents of which are incorporated herein by reference in their entirety.

### BACKGROUND OF THE INVENTION

In related art, a data packet duplication mechanism of a packet data convergence protocol (PDCP) entity typically duplicates and transmits all data packets.

### SUMMARY OF THE INVENTION

The present disclosure relates to, but is not limited to, the technical field of wireless communication, and in particular relates to a method, system, and device for controlling data transmission, a communication device, and a storage medium.

In a first aspect, a method for controlling data transmission is provided in the embodiments of the present disclosure. The method is performed by a network device and includes:
sending indication information to a terminal, where the indication information is configured to instruct a packet data convergence protocol (PDCP) entity of the terminal to enable a duplication mechanism for a data packet of a target type, or the indication information is configured to instruct the PDCP entity of the terminal not to enable the duplication mechanism for the data packet of the target type.

In a second aspect, a method for controlling data transmission is provided in the embodiments of the present disclosure. The method is performed by a terminal and includes:
receiving indication information; and
determining, based on the indication information, whether a PDCP entity of the terminal enables a duplication mechanism for a data packet of a target type.

In a third aspect, a method for controlling data transmission is provided in the embodiments of the present disclosure. The method is performed by a system for controlling data transmission. The system for controlling data transmission includes a network device and a terminal. The method includes:
sending indication information to the terminal by the network device; and
receiving the indication information by the terminal, and determining by the terminal, based on the indication information, whether a PDCP entity of the terminal enables a duplication mechanism for a data packet of a target type.

In a fourth aspect, a system for controlling data transmission is provided in the embodiments of the present disclosure. The system includes a network device and a terminal.

The network device is configured to perform the method of the first aspect.

The terminal is configured to perform the method of the second aspect.

In a fifth aspect, a device for controlling data transmission is provided in the embodiments of the present disclosure. The device is applied to a network device and includes:
a processing module configured to send indication information to a terminal, where the indication information is configured to instruct a PDCP entity of the terminal to enable a duplication mechanism for a data packet of a target type, or the indication information is configured to instruct the PDCP entity of the terminal not to enable the duplication mechanism for the data packet of the target type.

In a sixth aspect, a device for controlling data transmission is provided in the embodiments of the present disclosure. The device is applied to a terminal and includes:
a processing module configured to receive indication information, and determine, based on the indication information, whether a PDCP entity of the terminal enables a duplication mechanism for a data packet of a target type.

In a seventh aspect, a communication device is provided in the embodiments of the present disclosure. The communication device includes one or more processors, a transceiver, a memory, and an executable program stored on the memory and capable of being run by the one or more processors. The one or more processors, when collectively running the executable program, perform the method for controlling data transmission according to any one of the foregoing embodiments.

In an eighth aspect, a non-transitory computer-readable storage medium is provided in the embodiments of the present disclosure. The non-transitory computer-readable storage medium stores an executable program. The executable program, when collectively executed by one or more processors, implements the method for controlling data transmission according to any one of the foregoing embodiments.

### BRIEF DESCRIPTION OF DRAWINGS

The drawings are incorporated in the description as a constituent part of the description, illustrate embodiments conforming to the present disclosure, and serve to explain principles of the present disclosure along with the description.

FIG. 1 is a schematic structural diagram of a wireless communication system according to an example.

FIG. 2 is a schematic diagram of interaction of a method for controlling data transmission according to an example.

FIG. 3 is a flowchart of a method for controlling data transmission according to an example.

FIG. 4 is a flowchart of a method for controlling data transmission according to an example.

FIG. 5 is a flowchart of a method for controlling data transmission according to an example.

FIG. 6 is a flowchart of a method for controlling data transmission according to an example.

FIG. 7 is a schematic diagram of interaction of a method for controlling data transmission according to an example.

FIG. 8 is a schematic structural diagram of a device for controlling data transmission according to an example.

FIG. 9 is a schematic structural diagram of a device for controlling data transmission according to an example.

FIG. 10 is a schematic structural diagram of a terminal according to an example.

FIG. 11 is a schematic structural diagram of a communication device according to an example.

### DETAILED DESCRIPTION OF THE INVENTION

Description will be made in detail to examples herein, and their instances are illustrated in the accompanying drawings. When the following description relates to the accompanying drawings, the same numbers in different accompanying drawings denote the same or similar elements, unless indicated otherwise. Implementations described in the following examples do not represent all implementations consistent with the embodiments of the present disclosure. Rather, they are merely instances of devices and methods consistent with some aspects of the embodiments of the present disclosure.

The term used in the embodiments of the present disclosure is merely for the purpose of describing particular embodiments and is not intended to limit the embodiments of the present disclosure. As used in the present disclosure, singular forms “a,” “an,” and “the” are intended to include plural forms as well, unless otherwise indicated in the context clearly. It is also to be understood that the term “and/or” used herein refers to and contains any or all possible combinations of one or more of the associated items listed.

It is to be understood that while the terms “first,” “second,” “third,” etc. can be employed in the embodiments of the present disclosure to describe various information, such information is not limited to these terms. These terms are merely used to distinguish between a same type of information. For example, first information may also be referred to as second information, and similarly, second information may also be referred to as first information, without departing from the scope of the embodiments of the present disclosure. The word “if” as used herein may be construed to mean “at the time of” or “when” or “in response to determining,” depending on the context.

In related art, a data packet duplication mechanism of a packet data convergence protocol (PDCP) entity typically duplicates and transmits all data packets. However, under different scenario requirements, such as in an extended reality (XR) service, not all data packets need to be duplicated.

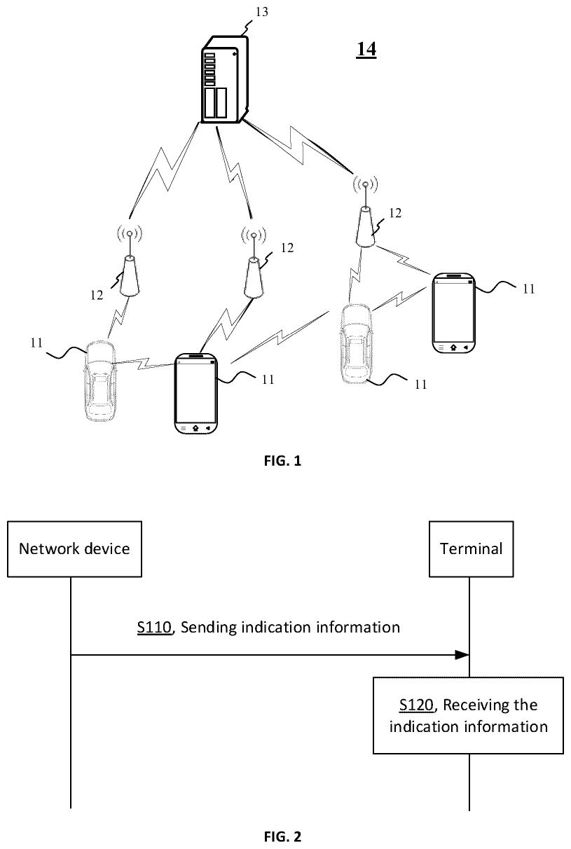

With reference to FIG. 1, a schematic structural diagram of a wireless communication system according to an embodiment of the present disclosure is shown. As shown in FIG. 1, the wireless communication system 14 is a communication system based on cellular mobile communication, and may include several terminals 11 and several access devices 12.

The terminal 11 may be a device that provides at least one of speech or data connectivity for a user. The terminal 11 may communicate with one or more core networks through a radio access network (RAN). The terminal 11 may be an Internet of Things terminal, for example, a sensor device, a mobile telephone (or referred to as a “cellular” telephone), and a computer having an Internet of Things terminal. The terminal 11 may be, for example, a stationary, portable, pocket-sized, hand-held, computer-built, or vehicle-mounted device, for example, a station (STA), a subscriber unit, a subscriber station, a mobile station, a mobile, a remote station, an access point, a remote terminal, an access terminal, a user device, a user agent, a user equipment (UE), or a user terminal. Alternatively, the terminal 11 may be an unmanned aerial vehicle. Alternatively, the terminal 11 may be an in-vehicle device, for example, a trip computer with a wireless communication function, or a wireless communication device to which a trip computer is externally connected. Alternatively, the terminal 11 may be a roadside device, for example, a street lamp, a signal lamp, another roadside device, etc., with the wireless communication function.

The access device 12 may be a network node device in the wireless communication system. The wireless communication system may be a 4th generation mobile communication (4G) system, which is also referred to as a long term evolution (LTE) system. Alternatively, the wireless communication system may be a 5th generation mobile communication (5G) system, which is also referred to as a new radio (NR) system or a 5G NR system. Alternatively, the wireless communication system may be a next generation system consecutive to the 5G system. An access network of the 5G system may be referred to as a new generation-radio access network (NG-RAN). Alternatively, the wireless communication system may be a machine type communication (MTC) system.

The access device 12 may be an evolved node B (eNB) used in the 4G system.

Alternatively, the access device 12 may be a next generation node B (gNB) using a central-distributed architecture in the 5G system. In the case of central-distributed architecture, the access device 12 typically includes a central unit (CU) and at least two distributed units (DUs). The central unit is provided with a protocol stack of a packet data convergence protocol (PDCP) layer, a radio link control (RLC) layer, and a media access control (MAC) layer. The distributed unit is provided with a protocol stack of a physical (PHY) layer. Particular implementations of the access device 12 are not limited to the embodiments of the present disclosure.

The access device 12 may be in wireless connection to the terminal 11 through a wireless radio. The wireless radio may be a wireless radio based on a standard of the 4th generation mobile communication (4G). Alternatively, the wireless radio may be a wireless radio based on a standard of the 5th generation mobile communication (5G), for example, the wireless radio may be a new radio. Alternatively, the wireless radio may be a wireless radio based on a standard of next generation mobile communication following 5G.

For example, the wireless communication system 14 may include a network management device 13. Several access devices 12 are individually connected to the network management device 13. The network management device 13 may be a core network device in the wireless communication system 14. For example, the network management device 13 may be a mobility management entity (MME) in an evolved packet core (EPC). Alternatively, the network management device 13 may be another core network device, such as a serving gateway (SGW), a public data network gateway (PGW), a policy and charging rules function (PCRF), or a home subscriber server (HSS). An implementation form of the network management device 13 is not limited to the embodiments of the present disclosure.

In an example, the terminal 11 may be a terminal in the embodiments of the present disclosure. For example, the terminal 11 may be UE. The UE may include, but is not limited to, at least one of a mobile phone, a wearable device, a vehicle-mounted terminal, a road side unit (RSU), a smart home terminal, an industrial sensing device, or a medical device. The access device 12 may be a network device, such as a base station, in the embodiments of the present disclosure.

As shown in FIG. 2, a method for controlling data transmission is provided in the embodiments of the present disclosure. The method includes steps S110 and S120.

In step S110, a network device sends indication information.

In step S120, a terminal receives the indication information.

In some embodiments, the network device sends the indication information to the terminal. Accordingly, the terminal receives the indication information sent by the network device.

In some embodiments, the indication information is configured to instruct a packet data convergence protocol (PDCP) entity of the terminal whether to enable a duplication mechanism for a data packet of a target type. For example, the indication information may instruct the PDCP entity of the terminal to enable the duplication mechanism for the data packet of the target type, or the indication information may instruct the PDCP entity of the terminal not to enable the duplication mechanism for the data packet of the target type. Accordingly, when receiving the indication information, the terminal may perform a corresponding operation.

In the embodiments of the present disclosure, the network device may be a base station or the like. The PDCP entity may be located in the terminal. Enabling the duplication mechanism may include duplicating the data packet and sending the duplicated data packet to one or more associated radio link control (RLC) entities. The associated RLC entity may be an RLC entity activated for the duplication mechanism.

For example, the RLC entity may include a primary RLC entity and a secondary RLC entity. The PDCP entity may send a control protocol data unit (PDU) in the data packet, and the duplicated data packet to the primary RLC entity, and the duplicated data packet to the secondary RLC entity. The duplicated data packet may be a data packet corresponding to a data PDU. It is to be understood that the duplicated data packet may alternatively be another data packet, which is not limited herein.

In an embodiment, the primary RLC entity may be an RLC entity communicating with the PDCP entity through a primary link (or referred to as a master leg). The secondary RLC entity may be an RLC entity communicating with the PDCP entity through a secondary link (or referred to as a secondary leg).

In an embodiment, the duplication mechanism for the data packet of the target type may include a duplication mechanism for at least one of: the data packet of the target type, or a set of data packets of the target type. Enabling the duplication mechanism may refer to activating the duplication mechanism, triggering the duplication mechanism, configuring the duplication mechanism, or making the duplication mechanism take effect. Not enabling the duplication mechanism may refer to deactivating the duplication mechanism, de-triggering the duplication mechanism, de-configuring the duplication mechanism, or making the duplication mechanism ineffective, etc. The data packet may be one or more data packets in a data set.

In an embodiment, not enabling the duplication mechanism for the data packet of the target type may include not duplicating the data packet of the target type, or may include not sending the data packet of the target type to the RLC entity.

In an embodiment, the target type indicates at least one of the following: importance, a service type, a quality-of-service flow (QOS flow) identity document (ID), a sub QoS flow ID, or a priority corresponding to at least one of the data packet or the set of data packets. The importance may be indicated by an importance level. One quality-of-service flow identity document may correspond to a plurality of sub quality-of-service flow identity documents. The sub quality-of-service flow identity documents may be configured to further distinguish different data packets corresponding to a same quality-of-service flow identity document. In some embodiments, the data packet of the target type may be a data packet having or corresponding to a specific service type, a specific quality-of-service flow identity document, a specific sub QoS flow ID, or a specific priority.

In an embodiment, the indication information may include a flag, for example, an explicit or implicit flag, indicating whether to enable the duplication mechanism. The flag may be one field or one bit, etc. For example, in a case where the flag is “1,” it instructs the PDCP entity of the terminal to enable the duplication mechanism for the data packet of the target type; in a case where the flag is “0,” it instructs the PDCP entity not to enable the duplication mechanism for the data packet of the target type. It is to be understood that other flags may also be configured to instruct the PDCP entity of the terminal to enable the duplication mechanism for the data packet of the target type or not to enable the duplication mechanism for the data packet of the target type.

In an embodiment, the indication information may further include information indicating the target type. For example, the indication information may carry a PDU Session ID (PSI) indicating the data packet of the target type. For example, the indication information may be borne by radio resource control (RRC) signaling or a media access control-control element (MAC-CE). The RRC signaling or the MAC-CE may carry one or more PSIs corresponding to the data packet of the target type.

In an embodiment, in a case where the RRC signaling or the MAC-CE carries a plurality of PSIs, the plurality of PSIs may be of a form of a PSI list, a PSI set, or the like.

In an embodiment, the indication information may be further configured to instruct the PDCP entity not to duplicate data packets of other types except the target type, that is, performs no duplication on the data packets of other types except the target type. For example, in a case where the indication information instructs the PDCP entity to enable the duplication mechanism for the data packet of the target type, the indication information may further instruct the PDCP entity to perform no duplication on the data packets of other types except the target type.

In an embodiment, instructing the PDCP entity to enable the duplication mechanism for the data packet of the target type may include instructing the PDCP entity to duplicate the data packet of the target type and to send the duplicated data packet of the target type to one or more RLC entities that are activated for a data packet duplication mechanism.

In an embodiment, sending the duplicated data packet of the target type to the one or more RLC entities that are activated for the data packet duplication mechanism may include: sending the duplicated data packet of the target type to some or all RLC entities that are activated for the data packet duplication mechanism. For example, in a case where three activated RLC entities (RLC1, RLC2, and RLC3) are provided, instructing the PDCP entity to enable the duplication mechanism for the data packet of the target type may include instructing the PDCP entity to duplicate the data packet of the target type and to send the duplicated data packet of the target type to the RLC1 and the RLC2.

In an embodiment, the indication information may also be configured to indicate an RLC entity to which the duplicated data packet of the target type needs to be sent. For example, the indication information may carry an identity document of the RLC entity to which the duplicated data packet needs to be sent.

For example, the network device may instruct, through the indication information, the PDCP entity to duplicate and send a set 1 of data packets of the target type to all RLC entities of the RLC1, the RLC2 and the RLC3 that are activated for the data packet duplication mechanism, and the network device may instruct, through the indication information, the PDCP entity not to duplicate a set 2 of the data packets of other types. Thus, the set 2 of data packets, different from the set 1 of data packets of the target type, does not need to be duplicated and sent to the three activated RLC entities. Alternatively, even if the set 2 of data packets, different from the set 1 of data packets of the target type, is duplicated, the set 2 of data packets is not sent to the RLC entities.

In an embodiment, the indication information may further carry an identity document of one or more RLC entities to which the duplicated data packet of the target type needs to be sent.

In an embodiment, the indication information may further instruct the PDCP entity not to duplicate the data packets of other types except the target type, or instruct the PDCP entity to send the data packets of other types except the target type to designated one or more RLC entities. For example, the indication information may further carry the identity document of one or more RLC entities to which the data packets of other types except the target type need to be sent.

For example, instructing the PDCP entity to duplicate and to send the set 1 of data packets of the target type to all RLC entities of the RLC1, the RLC2 and the RLC3 that are activated for the data packet duplication mechanism may include instructing the PDCP entity to duplicate and to send the set 2 of the data packets of other types only to the RLC1. In this way, for other types of unimportant data packets, a number of times of duplication and sending can be reduced, thus reducing bandwidth occupation.

In an embodiment, in a case where the indication information instructs the PDCP entity not to enable the duplication mechanism for the data packet of the target type, the indication information may also instruct the PDCP entity to enable a duplication mechanism for data packets of other types. For example, the data packet of the target type is not duplicated, and the data packets of other types are duplicated and sent to one or more RLC entities activated for the duplication mechanism.

In an embodiment, the RCL entity activated for the duplication mechanism may be configured to receive at least one type of data packets.

In an embodiment, the indication information instructing the PDCP entity not to enable the duplication mechanism for the data packet of the target type may include instructing the PDCP entity not to perform duplication on all types of data packets, or instructing the PDCP entity to duplicate all types of data packets. A condition that all types of data packets are duplicated is a data packet duplication mechanism in a legacy function.

In an embodiment, enabling the duplication mechanism for the data packet of the target type may include: sending the duplicated data packet of the target type to at least one secondary RLC entity activated for the duplication mechanism, and sending all data packets to the primary RLC entity.

In an embodiment, sending the indication information may include: sending the indication information in a case of determining that the data packet duplication mechanism has been activated for a radio bearer (RB) corresponding to the data packet of the target type. For example, step S110 may include: determining whether the data packet duplication mechanism has been activated for a data radio bearer (DRB) corresponding to the data packet of the target type; and sending the indication information in a case where the data packet duplication mechanism has been activated for the DRB.

In an embodiment, the DRB corresponding to the data packet of the target type may be a DRB for bearing the data packet of the target type. For example, the DRB may be a DRB associated with the PDCP entity of the terminal. One PDCP entity may be associated with one DRB.

In an embodiment, determining whether the data packet duplication mechanism has been activated for the DRB corresponding to the data packet of the target type may include: determining whether the network device has activated the data packet duplication mechanism for the DRB, etc. For example, it may be determined that whether the network device has activated the data packet duplication mechanism for the PDCP entity or an RLC entity associated with the DRB or a media access control (MAC) entity corresponding to the RLC entity.

In an embodiment, in a case where the indication information is configured to instruct the PDCP entity of the terminal to enable the duplication mechanism for the data packet of the target type, sending the indication information may include: receiving capability information; and sending the indication information in a case where the capability information indicates that the terminal has a capability of duplicating the data packet of the target type. The capability information may be information sent by the terminal to the network device, and is configured to indicate whether the terminal has the capability of duplicating the data packet of the target type.

In an embodiment, the capability information may be configured to determine whether the terminal has the capability of duplicating the data packet of the target type. For example, in a case where it is determined, based on the capability information, that the terminal has the capability, the indication information may be sent.

In an embodiment, the method may further include: sending first information to the terminal. The first information is configured to obtain the capability information.

In an embodiment, the capability information may be sent by the terminal to the network device in a case where the terminal determines to have the capability itself.

In an embodiment, the capability information may be sent in a case where the PDCP entity of the terminal detects a to-be-sent data packet. For example, in a case where the to-be-sent data packet is detected, or within a preset time period after the to-be-sent data packet is detected, the capability information is sent to the network device. The preset time period may be a fixed value, may be indicated to the terminal by the network device, or may be determined by the terminal based on a protocol or through negotiation with the network device.

In an embodiment, the terminal may alternatively send auxiliary information to the network device. The auxiliary information may be configured to indicate what types of data packets the terminal desires to duplicate. The network device may determine the target type based on the auxiliary information.

In an embodiment, the indication information may be borne by first RRC signaling, and the indication information includes a first information element (IE). The first IE carries at least one of the following: one or more first PSIs corresponding to the data packet of the target type, that is, a list of PSIs corresponding to the data packets of the target type that need to be duplicated; or one or more second PSIs corresponding to the data packets of other types except the target type, that is, a list of PSIs corresponding to data packets of the target type that does not need to be duplicated.

In an embodiment, the first IE may be an IE newly added in the first RRC signaling. For example, the first IE may be an IE newly added in IEs, such as “moreThanTwoRLC-DRB” in the first RRC signaling.

In an embodiment, it may instruct, according to an element (for example, PSI) carried in the first IE, the PDCP entity to duplicate the data packet of the target type. For example, in a case where the first IE carries a first PSI, it may instruct the PDCP entity to duplicate a data packet of the target type corresponding to the first PSI. In an example, in a case where the first IE carries the first PSI, it may further instruct the PDCP entity not to duplicate data packets corresponding to other PSIs except the first PSI. The first PSI may be a PSI corresponding to the data packet of the target type, for example, a PSI of a PDU session corresponding to the data packet of the target type. For example, each data packet may correspond to one PSI. In a case where the data packets of the target type include a plurality of data packets, the first IE may carry a plurality of first PSIs.

Similarly, in a case where the first IE carries a second PSI, it may instruct the PDCP entity not to duplicate a data packet corresponding to the second PSI. In an example, in a case where the first IE carries the second PSI, it may further instruct the PDCP entity to duplicate data packets corresponding to other PSIs except the second PSI. The second PSI may be a PSI corresponding to a data packet of another type except the target type, for example, a PSI of a PDU session corresponding to the data packet of the another type. For example, each data packet may correspond to one PSI. In a case where the data packets of the another type include a plurality of data packets, the first IE may carry a plurality second PSIs.

In an embodiment, signaling, used when the network device instructs the terminal to activate a function of performing packet duplication on the data packet of the target type, is the MAC-CE. The data packet of the target type may be indicated by a PSI of a specific type. The information of performing packet duplication on the data packet or a set of data packets with the PSI of the specific type may be configured in advance by the RRC signaling.

In an embodiment, the network device may also activate a function of performing packet duplication on the data packet of the target type through the MAC-CE. Moreover, the MAC-CE may also indicate that data packets or sets of data packets with PSIs of which specific types are to be subjected to packet duplication or not.

In an embodiment, in a case where the MAC-CE carries the first PSI, it may instruct the PDCP entity to duplicate the data packet of the target type corresponding to the first PSI, and may further instruct the PDCP entity not to duplicate data packets corresponding to other PSIs except the first PSI. In a case where the MAC-CE carries the second PSI, it may instruct the PDCP entity not to duplicate the data packet corresponding to the second PSI, and may further instruct the PDCP entity to duplicate data packets corresponding to other PSIs except the second PSI.

In an embodiment, the indication information may not carry at least one of the first PSI or the second PSI. For example, the indication information is only configured to indicate whether to enable the duplication mechanism. The data packet of the target type to which the duplication mechanism is applied may be indicated by another piece of RRC signaling.

In an example, the method may further include: sending second RRC signaling to the terminal. The second RRC signaling includes a second IE. The second IE carries at least one of the following: one or more first PSIs corresponding to the data packet of the target type; or one or more second PSIs corresponding to data packets of other types except the target type.

In an embodiment, since the terminal needs to determine the data packet of the target type and determine whether to enable the duplication mechanism for the data packet of the target type, the second RRC signaling is required to determine the target type in a case where the indication information does not indicate the data packet of the target type, for example, determine which data packets for duplication or which data packets for no duplication, etc.

In some embodiments, the second RRC signaling is sent to the terminal in a case where the indication information only instructs to enable the duplication mechanism or only instructs not to enable the duplication mechanism. For example, in a case where the indication information is only an explicit flag, the second RRC signaling needs to be sent to inform the terminal of the data packet corresponding to the duplication mechanism indicated by the indication information.

In some embodiments, the second RRC signaling is sent, in a case where the indication information is sent and the indication information does not indicate the data packet of the target type.

In an embodiment, sending the second RRC signaling may include sending the second RRC signaling to the terminal after receiving second information sent by the terminal. The second information may be configured to request the target type corresponding to the indication information.

In an embodiment, the network device may send the second RRC signaling to the terminal while the network device sends the indication information to the terminal. However, it is to be understood that the second RRC signaling may also be sent before or after the indication information is sent.

In an embodiment, the terminal may alternatively send auxiliary information to the network device. The auxiliary information may be configured to indicate what types of data packets the terminal desires to duplicate. The network device may determine the target type based on the received auxiliary information, and then send the indication information to the terminal.

In an embodiment, in a case where the network device instructs the PDCP entity to enable the duplication mechanism for the data packet of the target type, the PDCP entity duplicates and sends the data packet of the target type. A PDCP layer may count a data size sent by the PDCP entity. In a case where the data size counted by the PDCP layer of the terminal is sent to the MAC entity, the PDCP layer only counts a data size of the data packet of the target type duplicated and sent by the PDCP entity.

Illustratively, as for a data size sent to the primary RLC entity, all data needs to be counted. As for a data size of the secondary RLC entity with packet duplication activated, data packets of the target type that are duplicated and sent by the secondary RLC entity are counted. For example, a PSI of a specific type may correspond to a plurality of data packets, and a PDCP control PDU is not included since the PDCP control PDU is transmitted only at the primary RLC entity. Then, for an RLC entity with unactivated packet duplication, a statistical data size is 0. For a secondary RLC entity with activated packet duplication, a statistical data size is a data size of a plurality of data packets corresponding to the PSI of the specific type.

Illustratively, in a case where PDCP data packet duplication is activated for the RB, a PDCP data size is sent to an MAC entity associated with the primary RLC entity. A PDCP data size, corresponding to a relevant PSI, that does not include the PDCP control PDU is sent to the MAC entity associated with the RLC entity instead of the primary RLC entity with activated PDCP data packet duplication. The PDCP data size is indicated to be 0 to an MAC entity associated with the RLC entity with unactivated PDCP data packet duplication.

In this way, a network instructs the terminal whether to enable the duplication mechanism for a data packet of a specific target type, such that the terminal can be instructed to perform the packet duplication on the data packet more accurately. The terminal can determine, through an instruction of the network, a type of a data packet to be duplicated or not, such that power consumption and bandwidth waste caused by the fact that the terminal duplicates all data packets are reduced.

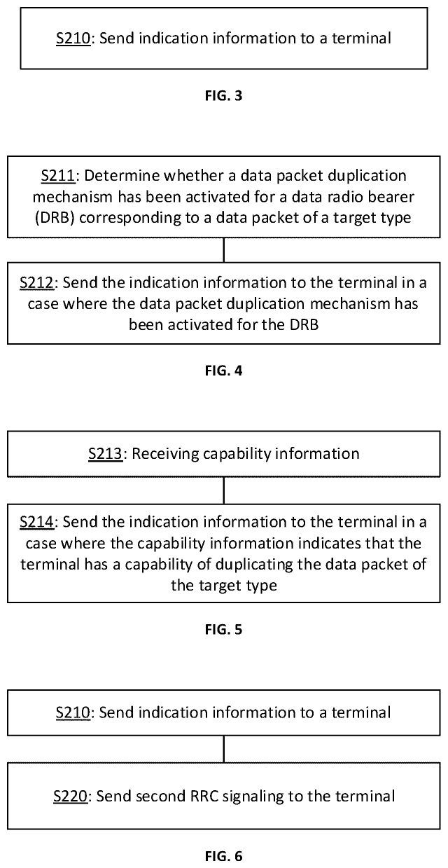

As shown in FIG. 3, a method for controlling data transmission is provided in the embodiments of the present disclosure. The method is performed by a network device and includes step S210.

In step S210, indication information is sent to a terminal.

The indication information is configured to instruct a PDCP entity of the terminal whether to enable a duplication mechanism for a data packet of a target type, or the indication information is configured to instruct the PDCP entity of the terminal not to enable the duplication mechanism for the data packet of the target type.

In an embodiment, enabling the duplication mechanism for the data packet of the target type may include:
duplicating the data packet of the target type; and
sending the duplicated data packet of the target type to one or more RLC entities that are activated for a data packet duplication mechanism.

In the embodiment of the present disclosure, the indication information may further carry an identity document of one or more RLC entities. The PDCP entity needs to send the duplicated data packet of the target type to the one or more RLC entities.

For example, in an embodiment, in the RLC entities associated with the PDCP entity, RLC entities that are activated for the data packet duplication mechanism are an RLC1, an RLC2, and an RLC3. Data packets to be sent by the PDCP entity may include two sets of data packets, that is, set 1 and set 2. For example, the indication information may instruct the PDCP entity to duplicate and send the set 1 of data packets of the target type to all RLC entities of the RLC1, the RLC2, and the RLC3 that are activated for the data packet duplication mechanism, and the indication information may instruct the PDCP entity not to duplicate the set 2 of data packets of other types.

In an embodiment, the indication information may further instruct the PDCP entity not to duplicate the data packets of other types except the target type, or instruct the PDCP entity to send the data packets of other types except the target type to designated one or more RLC entities. For example, the indication information may further carry the identity document of one or more RLC entities to which the data packets of other types except the target type need to be sent.

For example, in an embodiment, in the RLC entities associated with the PDCP entity, RLC entities that are activated for the data packet duplication mechanism are an RLC1, an RLC2, and an RLC3. Data packets to be sent by the PDCP entity may include two sets of data packets, that is, set 1 and set 2. For example, the indication information may instruct the PDCP entity to duplicate and send the set 1 of data packets of the target type to all RLC entities of the RLC1, the RLC2, and the RLC3 that are activated for the data packet duplication mechanism, and the indication information may instruct the PDCP entity to duplicate and send the set 2 of data packets of other types only to the RLC1. In this way, for other types of unimportant data packets, a number of times of duplication and sending can be reduced, thus reducing bandwidth occupation.

In some embodiments, not enabling the duplication mechanism for the data packet of the target type may include:
not duplicating all types of data packets; or, duplicating all types of data packets.

In an embodiment, in a case where the indication information instructs the PDCP entity not to enable the duplication mechanism for the data packet of the target type, the indication information may also instruct the PDCP entity to enable the duplication mechanism for the data packets of other types. For example, the data packet of the target type is not duplicated, and the data packets of other types are duplicated and sent to one or more RLC entities activated for the duplication mechanism.

In an embodiment, the RCL entity activated for the duplication mechanism may be configured to receive at least one type of data packets.

In an embodiment, the indication information instructing the PDCP entity not to enable the duplication mechanism for the data packet of the target type may include instructing the PDCP entity not to perform duplication on all types of data packets, or instructing the PDCP entity to duplicate all types of data packets. A condition that all types of data packets are duplicated is a data packet duplication mechanism in a legacy function.

In an embodiment, enabling the duplication mechanism for the data packet of the target type may include: sending the duplicated data packet of the target type to at least one secondary RLC entity activated for the duplication mechanism; and sending all data packets to the primary RLC entity.

In this way, by explicitly indicating the types of data packets that need to be duplicated or not, the terminal can duplicate and transmit the required data packets more accurately and efficiently, thus reducing bandwidth occupation and resource waste caused by duplicating all types of data packets.

In some embodiments, as shown in FIG. 4, step 210 may include steps S211 and S212.

In step S211, it is determined whether the data packet duplication mechanism has been activated for a DRB corresponding to the data packet of the target type.

In step S212, the indication information is sent in a case where the data packet duplication mechanism has been activated for the DRB.

In the embodiment of the present disclosure, the indication information is configured to instruct the PDCP entity of the terminal whether to enable the duplication mechanism for the data packet of the target type.

In an embodiment, it may be determined whether the data packet duplication mechanism has been activated for the DRB by determining whether a packet corresponding to the DRB has enabled the duplication mechanism.

In an embodiment, step S212 may include: receiving, in a case where the data packet duplication mechanism has been activated for the DRB, capability information sent by the terminal; and sending the indication information in a case where the capability information indicates that the terminal has a capability of duplicating the data packet of the target type.

In an embodiment, in a case where the data packet duplication mechanism has been activated for the DRB, the indication information instructing to enable the duplication mechanism for the data packet of the target type may be sent.

In this way, in a case where the data packet duplication mechanism has been activated for the DRB, the PDCP entity may be instructed whether to enable the duplication mechanism for the data packet of the target type corresponding to the DRB. Thus, a success rate of enabling the data packet duplication mechanism is improved.

In some embodiments, in a case where the indication information is configured to instruct the PDCP entity of the terminal to enable the duplication mechanism for the data packet of the target type, as shown in FIG. 5, step S210 may include steps S213 and S214.

In step S213, capability information is received.

In some embodiments, the network device may receive the capability information sent by the terminal. The capability information may be configured to determine whether the terminal has the capability of duplicating the data packet of the target type. For example, in a case where it is determined, based on the capability information, that the terminal has the capability, the indication information may be sent.

In an embodiment, before step S213, the method may further include: sending first information to the terminal. The first information is configured to obtain the capability information.

In an embodiment, the capability information may be sent by the terminal to the network device in a case where the terminal determines to have the capability itself.

In an embodiment, the capability information may be sent in a case where the PDCP entity of the terminal detects a to-be-sent data packet. For example, in a case where the to-be-sent data packet is detected, or within a preset time period after the to-be-sent data packet is detected, the capability information is sent to the network device. The preset time period may be a fixed value, may be indicated to the terminal by the network device, or may be determined by the terminal based on a protocol or through negotiation with the network device.

In step S214, the indication information is sent in a case where the capability information indicates that the terminal has a capability of duplicating the data packet of the target type.

In an embodiment, the indication information is borne by first RRC signaling, and the indication information includes a first IE. The first IE carries at least one of the following: one or more first PSIs corresponding to the data packet of the target type; or one or more second PSIs corresponding to the data packets of other types except the target type.

In an embodiment, the indication information is borne by an MAC-CE, and the MAC-CE carries at least one of the following: one or more first PSIs corresponding to the data packet of the target type; or one or more second PSIs corresponding to the data packets of other types except the target type.

In an embodiment, step S214 may include: determining whether the data packet duplication mechanism has been activated for a DRB corresponding to the data packet of the target type in a case where the capability information indicates that the terminal has the capability of duplicating the data packet of the target type; and sending the indication information in a case where the data packet duplication mechanism has been activated for the DRB.

In an embodiment, the capability information may indicate the corresponding target type, for example, may carry the PSI corresponding to the data packet of the target type.

In an embodiment, the method may further include: requesting the capability information from the terminal. The capability information indicates whether the terminal has the capability of duplicating the data packet of the target type.

In this way, in a case where the terminal capability supports to enable the duplication mechanism for the data packet of the target type, a corresponding indication is given to the PDCP entity, thus further improving the success rate of enabling the data packet duplication mechanism.

In some embodiments, as shown in FIG. 6, the method may further include step S220.

In step S220, second RRC signaling is sent to the terminal.

The second RRC signaling includes a second IE. The second IE carries at least one of the following: one or more first PSIs corresponding to the data packet of the target type; or one or more second PSIs corresponding to the data packets of other types except the target type.

FIG. 6 does not limit a performance order of steps S210 and S220. In an embodiment, steps S220 and S210 may be performed simultaneously or may be performed sequentially. The performance order may be arbitrarily changed, which is not limited herein.

In an embodiment, the second IE may be an IE newly added in the second RRC signaling. For example, the second IE may be an IE newly added in IEs, such as “moreThanTwoRLC-DRB” in the second RRC signaling.

In this way, in a case where the target type has been indicated through the second RRC signaling, the indication information may not need to indicate the target type again, but may only indicate whether to enable the duplication mechanism. Thus, the data size of the indication information is reduced, and resource overhead is reduced.

It is to be noted that reference may be made to steps and optional implementations in the embodiment of FIG. 2 for contents in the foregoing embodiments that are partially repeated or correspond to the embodiment of FIG. 2, which is not repeated herein.

As shown in FIG. 7, a method for controlling data transmission is provided in the embodiments of the present disclosure. The method is performed by a terminal and includes steps S310 and S320.

In step S310, indication information is received.

In some implementations, the terminal may receive the indication information sent by a network device. Specific descriptions of the indication information and other related contents have been described in detail in the other embodiments, which are not repeated herein.

In step S320, it is determined, based on the indication information, whether a PDCP entity of the terminal enables a duplication mechanism for a data packet of a target type.

In an embodiment, enabling the duplication mechanism for the data packet of the target type may include:
duplicating the data packet of the target type; and
sending the duplicated data packet of the target type to one or more RLC entities that are activated for a data packet duplication mechanism.

In an embodiment, the indication information is further configured to instruct the PDCP entity not to duplicate data packets of other types except the target type.

In an embodiment, not enabling the duplication mechanism for the data packet of the target type may include:
not duplicating all types of data packets; or
duplicating all types of data packets.

In an embodiment, the indication information is sent by the network device in a case of determining that the data packet duplication mechanism has been activated for a DRB corresponding to the data packet of the target type.

In an embodiment, the method further includes:
sending capability information to the network device, where the capability information indicates whether the terminal has a capability of duplicating the data packet of the target type.

In some embodiments, the terminal receives first information sent by the network device, and the terminal sends the capability information to the network device. For example, in a case where the terminal receives the first information sent by the network device, the terminal may send the capability information to the network device. The first information may be configured to request the capability information. A form, carrier, content, etc., of the first information are not limited herein.

In an embodiment, the capability information may be sent by the terminal to the network device in a case where the terminal determines to have the capability itself.

In an embodiment, the capability information may be sent in a case where the PDCP entity of the terminal detects a to-be-sent data packet. For example, in a case where the to-be-sent data packet is detected, or within a preset time period after the to-be-sent data packet is detected, the capability information is sent to the network device. The preset time period may be a fixed value, may be indicated to the terminal by the network device, or may be determined by the terminal based on a protocol or through negotiation with the network device.

In an embodiment, the target type indicates at least one of the following:
importance, a service type, a quality-of-service flow identity document, a sub quality-of-service flow identity document, or a priority corresponding to the data packet.

In an embodiment, the data packet of the target type is indicated by one or more PSIs.

In an embodiment, the indication information is borne by first RRC signaling or an MAC-CE.

In an embodiment, the indication information is borne by the first RRC signaling, and the indication information includes a first IE. The first IE carries at least one of the following: one or more first PSIs corresponding to the data packet of the target type; or one or more second PSIs corresponding to the data packets of other types except the target type.

In an embodiment, the indication information is borne by the MAC-CE, and the MAC-CE carries at least one of the following: one or more first PSIs corresponding to the data packet of the target type; or one or more second PSIs corresponding to the data packets of other types except the target type.

In an embodiment, the method further includes:
receiving second RRC signaling, where the second RRC signaling includes a second IE.

The second IE carries at least one of the following: one or more first PSIs corresponding to the data packet of the target type; or one or more second PSIs corresponding to data packets of other types except the target type.

In some embodiments, since the terminal needs to determine the data packet of the target type and determine whether to enable the duplication mechanism for the data packet of the target type, the second RRC signaling is required to determine the target type in a case where the indication information does not indicate the data packet of the target type, for example, determine which data packets for duplication or which data packets for no duplication, etc.

In some embodiments, the second RRC signaling is received in a case where the indication information only instructs to enable the duplication mechanism or only instructs not to enable the duplication mechanism. For example, in a case where the indication information is only an explicit flag, the second RRC signaling needs to be received to determine the data packet corresponding to the duplication mechanism indicated by the indication information.

In some embodiments, the second RRC signaling is received, in a case where the indication information is received and the indication information does not indicate the data packet of the target type.

In an embodiment, receiving the second RRC signaling may include: sending second information to the network device, and receiving the second RRC signaling sent by the network device. The second information may be configured to request the target type corresponding to the indication information.

It is to be noted that reference may be made to steps and optional implementations in the embodiments of FIG. 2 to FIG. 5 for contents in the foregoing embodiments that are partially repeated or correspond to the embodiment on a network device side, which is not repeated herein.

A method for controlling data transmission is provided in the embodiments of the present disclosure. The method is performed by a system for controlling data transmission (not shown). The system for controlling data transmission includes a network device and a terminal. The method includes:
sending indication information to the terminal by the network device; and
receiving the indication information by the terminal, and determining by the terminal, based on the indication information, whether an entity of the terminal enables a duplication mechanism for a data packet of a target type.

In some embodiments, the terminal sends capability information to the network device. The network device receives the capability information, and sends the indication information in a case where the capability information indicates that the terminal has a capability of duplicating the data packet of the target type. The capability information may be information sent by the terminal to the network device, and is configured to indicate whether the terminal has the capability of duplicating the data packet of the target type.

In an embodiment, the capability information may be configured to determine whether the terminal has the capability of duplicating the data packet of the target type. For example, in a case where it is determined, based on the capability information, that the terminal has the capability, the indication information may be sent.

In an embodiment, the method may further include sending first information to the terminal. The first information is configured to obtain the capability information.

In an embodiment, the capability information may be sent by the terminal to the network device in a case where the terminal determines to have the capability itself.

In an embodiment, the capability information may be sent in a case where the PDCP entity of the terminal detects a to-be-sent data packet. For example, in a case where the to-be-sent data packet is detected, or within a preset time period after the to-be-sent data packet is detected, the capability information is sent to the network device. The preset time period may be a fixed value, may be indicated to the terminal by the network device, or may be determined by the terminal based on a protocol or through negotiation with the network device.

In an embodiment, the terminal may further send auxiliary information to the network device. The auxiliary information may be configured to indicate what types of data packets the terminal desires to duplicate. The network device may determine the target type based on the auxiliary information.

In some embodiments, the network device may further send second RRC signaling to the terminal. The second RRC signaling includes a second IE. The second IE carries at least one of the following: one or more first PSIs corresponding to the data packet of the target type; or one or more second PSIs corresponding to data packets of other types except the target type. The network device sends the second RRC signaling in a case where the indication information does not indicate the data packet of the target type.

It is to be noted that the relevant contents of the above steps have been explained in other embodiments and the description of optional implementations, which are not repeated herein.

A method for controlling data transmission is provided in the embodiments of the present disclosure. The method may include:
1. A network configures a PDCP entity of a terminal to perform the packet duplication on data packets of a specific type.
a) Configuring/de-configuring this function, making the function take effect/making the function ineffective, or activating/deactivating the function are included.
b) The data packets include a plurality of data packets in a data set.
c) Classification dimensions of data of the specific type include importance, a service type, a QoS flow ID, or a sub QoS flow ID, a priority level, and other dimensions of the data.
d) The data packets may include only a PDCP data PDU and no PDCP control PDU.
e) The function may also be referred to as selective packet duplication, that is, packet duplication is only performed on data packets of the specific type, to satisfy reliability requirements of the data packets of the specific types. Packet duplication and transmission are not performed on other data packets. In this way, a better balance may be provided between reliability and resource usage.

2. The network uses dedicated signaling to configure the PDCP entity of the terminal to perform the packet duplication on the data packets of the specific type.
a) As an embodiment, the network may configure the PDCP entity of the terminal to perform the packet duplication on the data packets of the specific type based on an explicit flag. For example, enabling means that the packet duplication performed by the PDCP entity on the data packet of the specific type takes effect; otherwise, it does not take effect.
b) As an embodiment, not configuring/not taking effect/not activating may be that the packet duplication is not performed, or may fall back to a full duplication manner in a legacy function. That is, selective packet duplication is not performed on the data packets of the specific type, but the packet duplication is performed on all data packets in a case where PDCP packet duplication is activated.
c) As an embodiment, the specific type involved in the packet duplication for the data packets of the specific type may be agreed by a protocol or indicated by a network.

As an embodiment, the network instructs that the packet duplication and sending are performed on a data packet or a set of data packets with a particular PSI.

As an embodiment, the network instructs that the packet duplication and sending are not performed on a data packet or a set of data packets with a PSI of a specific type.

As an embodiment, the network instructs that the packet duplication and sending are performed on a data packet or a set of data packets with a PSI of a specific type by a specific RLC entity with activated packet duplication. The RLC entity with activated packet duplication may bear a plurality of types of duplicated packets.
d) As an embodiment, a network indication is RRC signaling for configuring the function or making the function take effect.

For example, one new IE is added to an IE of moreThanTwoRLC-DRB, indicating a list of PSIs for the packet duplication, that is, the packet duplication is performed only on the data packets with the PSIs of the specific type (the remaining needs no packet duplication); or indicating a list of PSIs needing no packet duplication.

As an embodiment, in a case where this IE is configured by the network, it means that the function takes effect. Alternatively, in a case where this IE is configured by the network, it means that the parameters of the function are configured by the network, but the network needs to send an explicit flag, such as an MAC-CE, to indicate whether the configuration takes effect.
e) As an embodiment, the network indication is an MAC-CE, which is configured to activate the function of the packet duplication for the data packet of the specific type. For example, the dedicated signaling is the MAC-CE, which is configured to activate the function of the packet duplication for the data packet of the specific type. The information of performing the packet duplication on the data packet or a set of data packets with the PSI of the specific type may be configured in advance by the RRC signaling.

As an embodiment, the MAC-CE may also be configured to activate a command to perform the function of the packet duplication on the data packet of the specific type. Moreover, the MAC-CE additionally indicates that data packets or sets of data packets with PSIs of which specific types are to be subjected to the packet duplication or not.
3. In an embodiment, the network configures the PDCP entity of the terminal to perform the packet duplication on the data packets of the specific type on the premise that the packet duplication has been activated for a DRB.
a) As an embodiment, the network may instruct the terminal to deactivate the function of the packet duplication for the data packet of the specific type, and in this case, it may fall back to the existing packet duplication mechanism.

As an embodiment, in a case of sending a PDCP PDU to a lower layer, the PDCP entity for sending needs to satisfy the following:
in a case where the PDCP entity for sending is associated with one RLC entity, the PDCP PDU is sent to the associated RLC entity;
in a case where the PDCP entity for sending is associated with at least two RLC entities and PDCP packet duplication has been activated for a corresponding RB, only packet duplication of the specific type is performed in a case where the sent PDCP PDU is a PDCP data PDU and packet duplication for a PSI of the specific type is activated, that is, the PDCP data PDU corresponding to this PSI is duplicated and the duplicated PDCP data PDU is sent to the associated RLC entity in which the PDCP duplication is activated for the PSI;
in a case where the packet duplication for the PSI of the specific type is not activated, an original packet duplication flow is performed, that is, the PDCP data PDU is duplicated and the PDCP data PDU is sent to the associated RLC entity in which the PDCP duplication is activated; and
in a case where the sent PDCP PDU is not a PDCP data PDU, a PDCP control PDU is sent to the primary RLC entity.
4. In an embodiment, the network configures the PDCP entity of the terminal to perform the packet duplication on the data packet of the specific type on the premise that a capability indication that the terminal has a capability to support the function is received.

In an embodiment, the terminal may also send auxiliary information to the network, indicating for which type of data packets the packet duplication is desired.
5. In an embodiment, the network configures the PDCP entity of the terminal to perform the packet duplication on the data packet of the specific type. In this case, the PDCP layer of the terminal may count a data size sent by the PDCP entity. In a case where the data size counted by the PDCP layer of the terminal is notified to the MAC entity, only the data packet of the specific type subjected to packet duplication and sending on the PDCP entity needs to be counted, and data packets without the packet duplication and sending need no counting.

As an embodiment, for the primary RLC entity, the data size statistics include all the data. For the secondary RLC entity on which the packet duplication is activated, the data size statistics includes statistics of the data packets of the specific type, such as the PSI of the specific type, subjected to the packet duplication and sending on the secondary RLC entity, and the data size statistics may include data packets corresponding to PSIs of a plurality of specific types. No PDCP control PDU is included in this case, since the PDCP control PDU is transmitted only at the primary RLC entity. For RLC entities where the packet duplication is not activated, 0 is reported.

As an embodiment, in a case where PDCP data packet duplication is activated for the RB, a PDCP data size is sent to an MAC entity associated with the primary RLC entity. A PDCP data size, corresponding to a relevant PSI, that does not include the PDCP control PDU is sent to the MAC entity associated with the RLC entity instead of the primary RLC entity with activated PDCP data packet duplication. The PDCP data size is indicated to be 0 to an MAC entity associated with the RLC entity with unactivated PDCP data packet duplication.

A system for controlling data transmission (not shown) is provided in the embodiments of the present disclosure. The system includes a network device and a terminal.

The network device is configured to perform the method of one or more technical solutions on the side of the network device.

The terminal is configured to perform the method of one or more technical solutions on the side of the terminal.

In the embodiment of the present disclosure, reference may be made to relevant contents on the terminal side in other embodiments for steps performed by the terminal and related contents, and reference may be made to relevant contents on the network device side in other embodiments for steps performed by the network device and related contents, which are not repeated herein.

As shown in FIG. 8, a device for controlling data transmission is provided in the embodiments of the present disclosure. The device for controlling data transmission 80 is applied to a network device and includes:
a processing module 10 configured to send indication information to a terminal, where the indication information is configured to instruct a PDCP entity of the terminal to enable a duplication mechanism for a data packet of a target type, or the indication information is configured to instruct the PDCP entity of the terminal not to enable the duplication mechanism for the data packet of the target type.

In the embodiments of the present disclosure, the processing module 10 may be configured to perform any corresponding steps and optional implementations of the network device in other embodiments, which is not repeated herein.

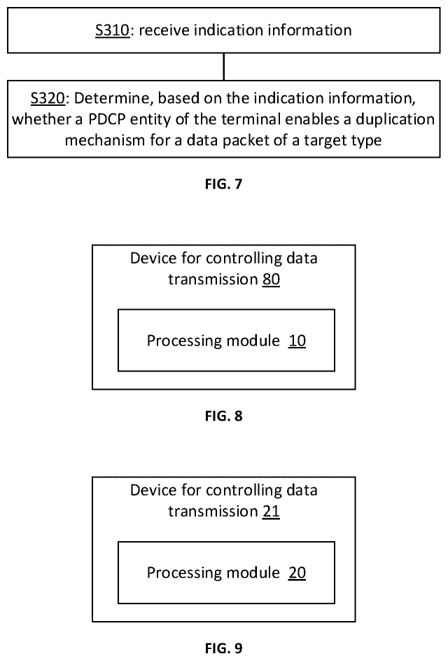

As shown in FIG. 9, a device for controlling data transmission is provided in the embodiments of the present disclosure. The device for controlling data transmission 21 is applied to a terminal and includes:
a processing module 20 configured to receive indication information, and determine, based on the indication information, whether a PDCP entity of the terminal enables a duplication mechanism for a data packet of a target type.

In the embodiments of the present disclosure, the processing module 20 may be configured to perform any corresponding steps and optional implementations of the terminal in other embodiments, which is not repeated herein.

Each step in an implementation or an embodiment can be implemented as an independent embodiment without contradiction, and steps can be arbitrarily combined. For example, a solution in which some steps are removed from an implementation or an embodiment can also be implemented as an independent embodiment, and an order of the steps in an implementation or an embodiment can be arbitrarily exchanged. Moreover, alternative ways or alternative instances in an implementation or an embodiment can be arbitrarily combined. Furthermore, various implementations or embodiments may be arbitrarily combined. For example, some or all steps of different implementations or embodiments may be arbitrarily combined. An implementation or embodiment may be arbitrarily combined with alternative ways or alternative instances of other implementations or embodiments.

A communication device is provided in the embodiments of the present disclosure. The communication device (not shown) includes:
a memory for storing processor-executable instructions, and
one or more processors collectively connected to the memory,
where the one or more processors are collectively configured to perform the method for controlling data transmission according to any one of the technical solutions of the present disclosure.

The one or more processors may include various types of storage media. The storage media are non-transitory computer storage media that can continue remembering information stored after the communication device is powered off.

The communication device includes a terminal or a network element. The network element may be any one of a first network element to a fourth network element.

The one or more processors may be collectively connected to the memory through a bus, etc. and configured to read an executable program stored on the memory, for example, at least one of the methods shown in FIG. 2 to FIG. 7.

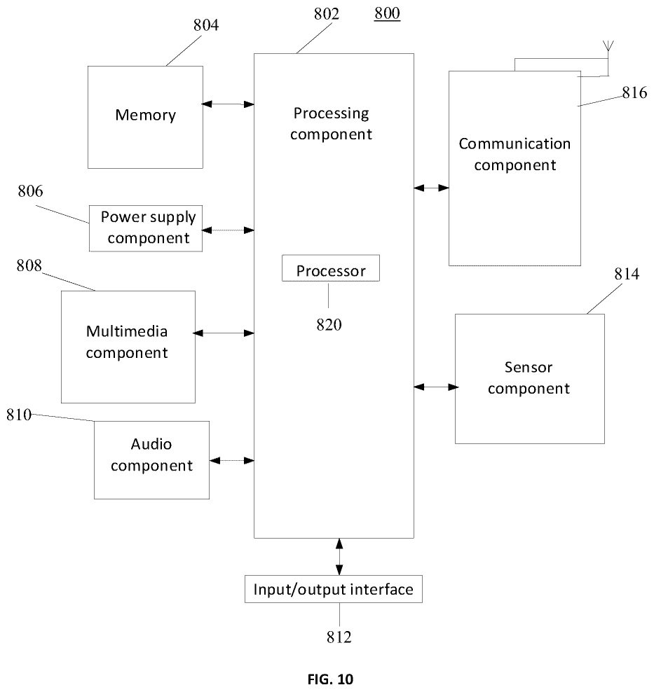

FIG. 10 is a block diagram of a terminal 800 according to an example. For example, the terminal 800 may be a mobile phone, a computer, digital broadcast user equipment, a message transceiver device, a gaming console, a tablet device, a medical device, a fitness device, a personal digital assistant, etc.

With reference to FIG. 10, the terminal 800 may include one or more of a processing component 802, a memory 804, a power supply component 806, a multimedia component 808, an audio component 810, an input/output (I/O) interface 812, a sensor component 814, and a communication component 816.

The processing component 802 generally controls the overall operation of the terminal 800, for example, operations associated with display, phone calls, data communications, camera operations, and recording operations. The processing component 802 may include one or more processors 820 to perform an instruction, so as to generate all or some steps of the method of the present disclosure. Moreover, the processing component 802 may include one or more modules that facilitate interaction between the processing component 802 and other components. For example, the processing component 802 may include a multimedia module, so as to facilitate interaction between the multimedia component 808 and the processing component 802.

The memory 804 is configured to store various types of data to support an operation on the terminal 800. Instances of such data include an instruction, operated on the terminal 800, for any application or method, contact data, phonebook data, messages, pictures, video, etc. The memory 804 may be implemented through any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The power supply component 806 supplies power to various assemblies of the terminal 800. The power supply component 806 may include a power management system, one or more power supplies, and other assemblies associated with power generation, management, and distribution for the terminal 800.

The multimedia component 808 includes a screen that provides an output interface between the terminal 800 and the user. In some embodiments, the screen may include a liquid crystal display (LCD) and a touch panel (TP). In a case of including the touch panel, the screen may be implemented as a touch screen, so as to receive an input signal from the user. The touch panel includes one or more touch sensors, so as to sense touches, slides, and gestures on the touch panel. The touch sensor may measure duration and a pressure associated with a touch or swipe operation while sensing a boundary of the touch or swipe action. In some embodiments, the multimedia component 808 includes at least one of a front-facing camera or a rear-facing camera. When the terminal 800 is in an operational mode, for example, a photographing mode or a video mode, at least one of the front-facing camera or the rear-facing camera may receive external multimedia data. Each of the front-facing camera and the rear-facing camera may be a fixed optical lens system or have a focal length and an optical zoom capability.

The audio component 810 is configured to output and/or input audio signals. For example, the audio component 810 includes a microphone (MIC) configured to receive an external audio signal when the terminal 800 is in operational modes, such as a call mode, a recording mode, and a speech recognition mode. The received audio signal may be further stored in the memory 804 or sent via the communication component 816. In some embodiments, the audio component 810 further includes a speaker configured to output an audio signal.

The I/O interface 812 provides an interface between the processing component 802 and a peripheral interface module. The peripheral interface module may be a keyboard, a click wheel, a button, etc. These buttons may include, but are not limited to, a home button, a volume button, a start button, and a lock button.

The sensor component 814 includes one or more sensors for providing state evaluation of various aspects of the terminal 800. For example, the sensor component 814 may detect an on/off state of the terminal 800 and relative positioning of the components. For example, the components are a display and a keypad of the terminal 800. The sensor component 814 may also detect a change in position of the terminal 800 or a component of the terminal 800, the presence or absence of contact between the user and the terminal 800, orientation or acceleration/deceleration of the terminal 800, and temperature variation of the terminal 800. The sensor component 814 may include a proximity sensor configured to detect presence of nearby objects in absence of any physical contact. The sensor component 814 may further include a light sensor, such as a complementary metal-oxide-semiconductor transistor (CMOS) or charge coupled device (CCD) image sensor for use in imaging applications. In some embodiments, the sensor component 814 may further include an acceleration sensor, a gyroscope sensor, a magnetic sensor, a pressure sensor, or a temperature sensor.

The communication component 816 is configured to facilitate communication between the terminal 800 and other devices in a wired or wireless mode. The terminal 800 may access a wireless network based on a communication standard, for example, Wi-Fi, 2G, or 3G, or their combinations. In an example, the communication component 816 receives a broadcast signal or broadcast related information from an external broadcast management system via a broadcast channel. In an example, the communication component 816 further includes a near field communication (NFC) module to facilitate short-distance communication. For example, the NFC module may be implemented based on a radio frequency identification (RFID) technology, an infrared data association (IrDA) technology, an ultra-wideband (UWB) technology, a Bluetooth (BT) technology, or other technologies.

In an example, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the method of the present disclosure.

In an example, a non-transitory computer-readable storage medium including instructions is further provided, for example, a memory 804 including instructions. The instructions are executable by the processor 820 of the terminal 800, to generate the methods of the present disclosure. For example, the non-transitory computer-readable storage medium may be an ROM, a random access memory (RAM), a compact disk (CD)-ROM, a magnetic tape, a floppy disk, an optical data storage device, etc.

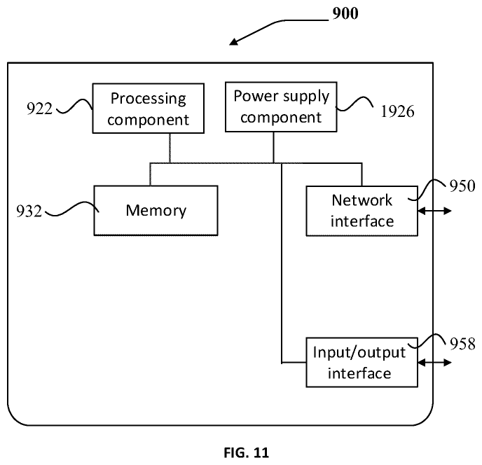

As shown in FIG. 11, a structure of a communication device 900 is shown according to an embodiment of the present disclosure. For example, the communication device 900 may be provided as a network node device. The communication device 900 may be the base station of the present disclosure.

With reference to FIG. 11, the communication device 900 includes: a processing component 922 including one or more processors; and memory resources represented by a memory 932 and configured to store an instruction executable by the processing component 922, for example, an application. The application stored in the memory 932 may include one or more modules, each of which corresponds to a set of instructions. Furthermore, the processing component 922 is configured to execute an instruction, so as to implement any one of the methods applied to the network device, for example, at least one of the methods shown in FIG. 2 to FIG. 7.

The communication device 900 may further include a power supply component 926 configured to perform power supply management of the communication device 900, a wired or wireless network interface 950 configured to connect the communication device 900 to a network, and an input/output (I/O) interface 958. The communication device 900 may operate based on an operating system stored in the memory 932, such as Windows Server™, Mac OS X™, Unix™, Linux™, and FreeBSD™. As used herein, the term “processor” may refer to one processor that performs the defined functions or a plurality of processors that collectively perform defined functions, such that the execution of the individual defined functions may be divided amongst such processors.

Those skilled in the art will readily conceive of other embodiments of the present disclosure after consideration of the description and practice of the present disclosure. The disclosure is intended to cover any variations, uses, or adaptive changes of the present disclosure, and these variations, uses, or adaptive changes follow general principles of the present disclosure and include common general knowledge or customary technical means in the technical field not disclosed in the present disclosure. The description and the embodiments are merely deemed as illustrative, and the true scope and spirit of the present disclosure are indicated by the following claims.

It is to be understood that the present disclosure is not limited to the precise structures that have been described above and shown in the accompanying drawings, and that various modifications and changes can be made without departing from the scope of the present disclosure. The scope of the present disclosure is limited only by the appended claims.

1. A method for controlling data transmission, performed by a network device, the method comprising:
sending indication information to a terminal, wherein the indication information is configured to instruct a packet data convergence protocol (PDCP) entity of the terminal to enable a duplication mechanism for a data packet of a target type, or the indication information is configured to instruct the PDCP entity of the terminal not to enable the duplication mechanism for the data packet of the target type.

2. The method according to claim 1, wherein enabling the duplication mechanism for the data packet of the target type comprises:
duplicating the data packet of the target type; and
sending the duplicated data packet of the target type to one or more radio link control (RLC) entities that are activated for a data packet duplication mechanism.

3. The method according to claim 2, wherein the indication information is further configured to instruct the PDCP entity not to duplicate data packets of other types except the target type.

4. The method according to claim 1, wherein in a case where the indication information is configured to instruct the PDCP entity of the terminal not to enable the duplication mechanism for the data packet of the target type, not enabling the duplication mechanism for the data packet of the target type comprises:
not duplicating all types of data packets; or
duplicating all types of data packets.

5. The method according to claim 1, wherein sending the indication information to the terminal comprises:
determining whether a data packet duplication mechanism has been activated for a data radio bearer (DRB) corresponding to the data packet of the target type; and
sending the indication information to the terminal in a case where the data packet duplication mechanism has been activated for the DRB.

6. The method according to claim 1, wherein in a case where the indication information is configured to instruct the PDCP entity of the terminal to enable the duplication mechanism for the data packet of the target type, sending the indication information to the terminal comprises:
receiving capability information; and
sending the indication information to the terminal in a case where the capability information indicates that the terminal has a capability of duplicating the data packet of the target type.

7. The method according to claim 1, wherein the target type indicates at least one of the following: importance, a service type, a quality-of-service flow identity document, a sub quality-of-service flow identity document, or a priority corresponding to the data packet; or
wherein the data packet of the target type is indicated by one or more protocol data unit session identity documents (PSIs).

8. (canceled)

9. (canceled)

10. The method according to claim 1, wherein the indication information is borne by first radio resource control (RRC) signaling; and
the indication information comprises a first information element (IE), wherein the first IE carries at least one of the following: one or more first protocol data unit session identity documents (PSIs) corresponding to the data packet of the target type; or one or more second PSIs corresponding to data packets of other types except the target type.

11. The method according to claim 1, wherein the indication information is borne by a medium access control-control element (MAC-CE); and
the MAC-CE carries at least one of the following: one or more first protocol data unit session identity documents (PSIs) corresponding to the data packet of the target type; or one or more second PSIs corresponding to data packets of other types except the target type.

12. The method according to claim 1, further comprising:
sending second radio resource control (RRC) signaling to the terminal, wherein the second RRC signaling comprises a second information element (IE), and the second IE carries at least one of the following: one or more first protocol data unit session identity documents (PSIs) corresponding to the data packet of the target type; or one or more second PSIs corresponding to data packets of other types except the target type.

13. A method for controlling data transmission, performed by a terminal, the method comprising:
receiving indication information; and
determining, based on the indication information, whether a packet data convergence protocol (PDCP) entity of the terminal enables a duplication mechanism for a data packet of a target type.

14. The method according to claim 13, wherein enabling the duplication mechanism for the data packet of the target type comprises:
duplicating the data packet of the target type; and
sending the duplicated data packet of the target type to one or more radio link control (RLC) entities that are activated for a data packet duplication mechanism.

15. The method according to claim 14, wherein the indication information is further configured to instruct the PDCP entity not to duplicate data packets of other types except the target type.

16. The method according to claim 13, wherein not enabling the duplication mechanism for the data packet of the target type comprises:
not duplicating all types of data packets; or
duplicating all types of data packets.

17. The method according to claim 13, wherein the indication information is sent by a network device in a case of determining that a data packet duplication mechanism has been activated for a data radio bearer (DRB) corresponding to the data packet of the target type.

18. The method according to claim 13, wherein the method further comprises:
sending capability information to a network device, wherein the capability information indicates whether the terminal has a capability of duplicating the data packet of the target type; or
wherein the method further comprises: receiving second radio resource control (RRC) signaling, wherein the second RRC signaling comprises a second information element (IE), and the second IE carries at least one of the following: one or more first protocol data unit session identity documents (PSIs) corresponding to the data packet of the target type; or one or more second PSIs corresponding to data packets of other types except the target type.

19. The method according to claim 13, wherein the target type indicates at least one of the following: importance, a service type, a quality-of-service flow identity document, a sub quality-of-service flow identity document, or a priority corresponding to the data packet; or
wherein the data packet of the target type is indicated by one or more protocol data unit session identity documents (PSIs).

20. (canceled)

21. (canceled)

22. The method according to claim 13, wherein the indication information is borne by first radio resource control (RRC) signaling; and the indication information comprises a first information element (IE), wherein the first IE carries at least one of the following: one or more first protocol data unit session identity documents (PSIs) corresponding to the data packet of the target type; or one or more second PSIs corresponding to data packets of other types except the target type; or
wherein the indication information is borne by a medium access control-control element (MAC-CE); and
the MAC-CE carries at least one of the following: one or more first protocol data unit session identity documents (PSIs) corresponding to the data packet of the target type; or
one or more second PSIs corresponding to data packets of other types except the target type.

23. (canceled)

24. (canceled)

25. (canceled)

26. (canceled)

27. (canceled)

28. (canceled)

29. A communication network device, comprising:
one or more processors;
a memory storing an executable program;
wherein the executable program, when collectively executed by the one or more processors, causes the network device to:
send indication information to a terminal, wherein the indication information is configured to instruct a packet data convergence protocol (PDCP) entity of the terminal to enable a duplication mechanism for a data packet of a target type, or the indication information is configured to instruct the PDCP entity of the terminal not to enable the duplication mechanism for the data packet of the target type.

30. (canceled)

31. A terminal, comprising:
one or more processors;
a memory storing an executable program;
wherein the executable program, when collectively executed by the one or more processors, causes the terminal to perform the method according to claim 13.
